(19) United States
(12) Patent Application Publication
(10) Pub. No.: US 2022/0222504 A1
(43) Pub. Date: Jul. 14, 2022

(54) RFID TAG WITH VARIABLE IDENTIFICATION VALUE

(71) Applicant: Saurabh Suresh Ambre, Santa Clara, CA (US)

(72) Inventor: Saurabh Suresh Ambre, Santa Clara, CA (US)

(21) Appl. No.: 17/147,381

(22) Filed: Jan. 12, 2021

(51) Int. Cl. G06K 19/077; G06K 19/07

(52) U.S. Cl. CPC G06K 19/07773; G06K 19/0723

(57) ABSTRACT

Devices and methods are disclosed related to Radio Frequency Identification (RFID) tags and RFID Integrated Circuit (IC). In some embodiments, the RFID tags are configured to facilitate the changing of the RFID tag values read without having to reprogram the data stored in the memory of the Integrated Circuits (“ICs”) associated with the RFID tags. In one embodiment, a RFID tag is provided with multiple ICs and the configuration of antennas associated with the ICs causes interference so that only certain ICs are active at a given time. In another embodiment, a RFID tag having multiple substrates and ICs, and a blocking material, is configured to effectively inactivate some of the ICs until the blocking material is removed. In some embodiments, couplings external to the RFID ICs are provided to change the RFID tag value read when the couplings are uncoupled. In one embodiment, a method of managing tags with multiples ICs is disclosed.

### BACKGROUND

### 1. Technical Field

Embodiments of the invention disclosed generally relate to systems and methods for Radio Frequency Identification (RFID).

### 2. Description of the Related Art

Radio Frequency Identification (RFID) systems use a Radio Frequency (RF) field generator (reader) to wirelessly extract identification information contained in RFID transponder tags that are attached to objects requiring accurate identification. RFID readers are also known as RFID reader/writer or beacons. The RFID reader/writer transmitting a RF wave performs the interrogation. The RF wave is typically electromagnetic, at least in the far field. The RF wave can also be predominantly electric or magnetic in the near field. RFID tags are miniature electronic circuits that typically consist of a coil that acts as an antenna and an Integrated Circuit (IC) with a memory, all encapsulated in a protective material. RFID tags are either available with a preprogrammed value (read-only) stored in the IC or can be reprogrammed (read-write) multiple times to store information usually in the form of an identification number, and/or other information associated with an object to which the RFID tag is attached. Each RFID tag has a unique identification (ID) which differentiates one RFID tag from another. The RFID tag identification number/value is also known as RFID tag value. When an RFID tag enters a radio frequency electromagnetic field generated by an RFID reader, the antenna of the RFID tag becomes energized causing the IC of the RFID tag to transmit the information stored within the memory of the IC to the RFID reader. The basic structure and operation of RFID tags can be found in, for example, U.S. Pat. No. 5,030,807, the disclosure of which is hereby incorporated by reference in its entirety.

A typical RFID tag consists of a single Integrated Circuit (IC) electrically connected to an antenna on a substrate. RFID tags are categorized as active, passive and semi-passive tags. Passive tags do not contain a power source or are battery-less tags. Rather, they become inductively or capacitively charged when they enter an RF field and transmit/relay information back to the RFID reader/writers.

RFID systems are used in diverse industries especially in product and service-related applications like asset tracking, security monitoring, inventory management, etc. In a retail environment, when an RFID tag is coupled to a product, it is usually for security purposes to prevent theft. Typically, once the product is checked out of the store, the RFID tag has likely served its purpose and does not add any value to the end user, buyer, or customer, thus limiting the use of the RFID tags.

RFID tags that have a pre-programmed value (read-only) or are programmed only once may be compared to barcodes which have an unchangeable value. Usually in supply chain management, RFID tags with fixed value are used for inventory management wherein, once an RFID tag is coupled with an item, the RFID tag's value does not change throughout its lifecycle. This is because reprogramming RFID tags to change the data stored in the memory of the RFID IC typically requires controlled environment and/or procedures which are difficult to manage and organize in an environment where multiple RFID tags are present. In some applications it is not required to reprogram an RFID tag, while in other applications it is either expensive or not feasible to reprogram RFID tags due to technical limitations. Therefore, the item tagged with an RFID tag having a fixed unchanged value will have a set definition rather than a variable definition throughout its lifecycle.

There is a need in the art for RFID tag and RFID IC that can be modified. With inventive embodiments disclosed herein, the use of RFID tags can be expanded to unlock the potential of extensive use in diverse applications.

### BRIEF SUMMARY

Disclosed are systems and methods for configuring Radio Frequency Identification (RFID) tags, Integrated Circuits (ICs), and/or managing RFID tag values. In one aspect, the invention relates to a Radio Frequency Identification (RFID) tag having a substrate, a first integrated circuit (IC) deposited on the substrate, a first antenna coupled to the first IC, a second IC deposited on the substrate, a second antenna coupled to the second IC, wherein the first antenna is configured to cause an interference with the second antenna, and wherein such interference effectively inactivates the second IC; wherein the substrate is configured to facilitate a detaching of a first portion of the substrate supporting the first IC from a second portion of the substrate supporting the second IC; and wherein detaching of the first portion of the substrate effectively results in the activation of the second IC. In one embodiment, the first antenna is configured to cause an interference with the second antenna by the first antenna being larger than the second antenna. In another embodiment, first antenna is configured to cause an interference with the second antenna by the first antenna having a number of segments that are larger than the number of segments of the second antenna. In yet another embodiment, the first antenna is configured to cause an interference with the second antenna by the first antenna being fine-tuned relative to the second antenna. In some embodiments, a RFID tag value is derived from a value provided by the first IC or, alternatively, a value provided by the second IC, and wherein detaching the first portion, a RFID tag value is then given by the value of the second IC, and wherein the value of the RFID tag, therefore, changes without a reprogramming of the value stored in the first IC or the value stored in the second IC.

In another aspect, the invention concerns a Radio Frequency Identification (RFID) tag having a first substrate, a first integrated circuit (IC) deposited on the first substrate, a first antenna coupled to the first IC, a second substrate; a second IC deposited on the second substrate, a second antenna coupled to the second IC, a blocking material deposited on the first substrate, and wherein the blocking material is configured to cover the second IC and the second antenna to prevent the second antenna from receiving radio frequency electromagnetic waves. In one embodiment, the first substrate is removable from the RFID tag to thereby remove the first IC, the first antenna and the blocking material, and wherein the RFID tag remains with the second IC and the second antenna, thereby, resulting in the second IC being capable of receiving radio frequency electromagnetic waves. In another embodiment, a RFID tag value is derived from a value provided by the first IC or, alternatively, a value provided by the second IC, and further wherein removing the first substrate a RFID tag value is given by the value of the second IC, and wherein the value of the RFID tag, therefore, changes without a reprogramming of the value stored in the first IC or the value stored in the second IC.

In yet another aspect, the invention is directed to an Integrated Circuit (IC) for a Radio Frequency Identification (RFID) tag. The IC includes a processor block, a memory comprising a first memory subsection and a second memory subsection, wherein the first memory subsection and the second memory subsection are each separately, coupled to the processor block; and

wherein a coupling between the second memory subsection and the processor block is configured to be uncoupled and, thereby, prevent the processor block from receiving data from the second memory subsection. In one embodiment, the coupling between the second memory subsection and the processor block is traced externally outside the integrated circuit. In another embodiment, the coupling is externally accessible. In yet another embodiment, a RFID tag value is derived from combining data stored in the first memory subsection and data stored in the second memory subsection, and further wherein uncoupling the second memory subsection results in a RFID tag value defined by data stored in the first memory subsection and without the data stored in the second memory subsection, and wherein the value of the RFID tag, therefore, changes without a reprogramming of the data stored in the first memory subsection or the data stored in the second memory subsection. In some embodiments, the processor block is configured to return only data stored in the first memory subsection or, alternatively, data stored in the first memory subsection and default data, when the second memory subsection is uncoupled from the processor block.

In one aspect, the invention concerns an Integrated Circuit (IC) for a Radio Frequency Identification (RFID) tag. The IC includes a processor block, an internal memory coupled to the processor block, an external memory coupled to the processor block, and wherein a coupling between the external memory and the processor block is configured to be uncoupled and, thereby, prevent the processor block from receiving data from the external memory. In one embodiment, the coupling between the external memory and the processor block is traced externally outside the integrated circuit. In another embodiment, the coupling is externally accessible. In yet another embodiment, a RFID tag value is derived from combining data stored in the internal memory and data stored in the external memory, and further wherein uncoupling the external memory results in a RFID tag value defined by data stored in the internal memory and without the data stored in the external memory, and wherein the value of the RFID tag, therefore, changes without a reprogramming of the data stored in the internal memory or the data stored in the external memory.

A further aspect of the invention relates to an Integrated Circuit (IC) for a Radio Frequency Identification (RFID) tag. The IC includes a processor block, a memory coupled to the processor block, an Analog-to-Digital Converter (ADC) coupled to the processor block, a sensor coupled to the ADC, and wherein a coupling between the ADC and the sensor is configured to be uncoupled and, thereby, prevent the ADC from receiving signals from the sensor. In one embodiment, the coupling between the ADC and the sensor is traced externally outside the integrated circuit. In another embodiment, the coupling is externally accessible. In yet another embodiment, a RFID tag value is derived from combining data stored in the memory and an input to the processor block provided by the ADC, wherein uncoupling the sensor results in changing said input, and wherein the value of the RFID tag, therefore, changes without a reprogramming of the value stored in the memory.

Yet another aspect of the invention relates to a Radio Frequency Identification (RFID) tag having a substrate, a first integrated circuit (IC) deposited on the substrate, a first antenna coupled to the first IC, a second IC deposited on the substrate, a second antenna coupled to the second IC,

wherein the first IC and the second IC are configured to be active simultaneously at a given time, wherein a value of the RFID tag is a combination of a value stored in the first IC and/or a value stored in the second IC; and wherein some of the value stored in the first IC and some of the value stored in the second IC is common to facilitate a determination that the first IC and the second IC are associated with the RFID tag. In one embodiment, the RFID tag comprises a first portion with the first IC deposited on the first portion, and wherein the RFID tag comprises a second portion with the second IC deposited on the second portion, and wherein the RFID tag is configured to facilitate a detaching of the second portion from the first portion. In another embodiment, the RFID tag is configured to provide a RFID tag value given by the value of the first IC only, after the second portion is detached from the first portion, and wherein the RFID tag value of the RFID tag, therefore, changes without a reprogramming of the value stored in the first IC or the value stored in the second IC.

In one aspect, the invention is directed to a method of managing Radio Frequency Identification (RFID) tags, each RFID tag having one or more integrated circuits. The method can include the steps of reading a plurality of RFID tags, storing a value of each integrated circuit (IC) associated with each RFID tag, identifying a common data associated with at least some of the stored values, identifying a primary IC value and a secondary IC value for each RFID tag, and combining the primary IC value and the secondary IC value to generate a value for each RFID tag. In one embodiment, the method can further include identifying a common data element from different RFID tag values and determining the quantity of RFID tags having the common data element.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

The invention itself will best be understood by reference to the following detailed description of an illustrative embodiment when read in conjunction with the accompanying drawings, wherein:

FIG. 1 is a schematic diagram of an RFID tag according to one embodiment of the invention.

FIG. 2 is a schematic diagram of the RFID tag of FIG. 1 used according to one embodiment of the invention.

FIG. 3 is an exploded view of an RFID tag according to another embodiment of the invention.

FIG. 4 is an assembled view of the RFID tag of FIG. 3 used according to one embodiment of the invention.

FIG. 5 is a block diagram of an integrated circuit of an RFID tag according to one embodiment of the invention.

FIG. 6 is a block diagram of an integrated circuit of an RFID tag according to another embodiment of the invention.

FIG. 7 is a block diagram of an integrated circuit according to yet another embodiment of the invention.

FIG. 8 is a schematic diagram of an RFID tag that can be used with methods according to certain embodiments of the invention.

FIG. 9 is a schematic diagram of the RFID tag of FIG. 8 used according to one embodiment of the invention.

FIG. 10 is a flow chart of a method of handling RFID tags according to one embodiment of the invention.

### DETAILED DESCRIPTION

Inventive embodiments disclosed herein apply to active, passive and semi-passive Radio Frequency Identification (RFID) tags. A passive RFID tag can consist of a substrate, antennas and an electrical circuit in the form of Integrated Circuit (IC), all of which can be made in known ways in this art. An RFID antenna can be made in multiple segments deposited on a substrate. In other cases, it is possible to use any number of antennas, antenna segments, antenna shape or design and antenna sizes, and the like. The IC can have one or more terminals for electrical connection to the antennas.

An RFID tag is configured to extract energy from an RFID reader. The antennas of an RFID tag extract energy from the radio frequency electromagnetic waves generated by the RFID reader to power the IC of an RFID tag. The amount of energy an antenna can extract from the radio frequency electromagnetic field depends on the antenna orientation, its ability to absorb the energy from the radio frequency electromagnetic field, and many other factors known in the art.

A surface can be used to block the RFID tag from receiving radio frequency electromagnetic waves generated by the RFID reader. The blocking surface can be made of a material that prevents radio frequency electromagnetic waves to pass through it thereby preventing the antennas of the RFID tag from absorbing energy from the RFID reader. The blocking surface can be, for example, a heavy metal surface or other materials known in the art that prevent radio frequency electromagnetic waves to pass through it.

Typically, as is known in the art, an RFID reader reads an RFID tag to reveal the data stored in the memory of the RFID IC of the RFID tag. To change the value of the RFID tag, the data stored in the memory of an RFID IC of the RFID tag is reprogrammed, usually using a RFID reader/writer. In contrast, in some embodiments described here, RFID tags and methods are disclosed that facilitate varying the value of an RFID tag without reprogramming the data stored in the memory of the RFID Integrated Circuits (ICs) of the RFID tag.

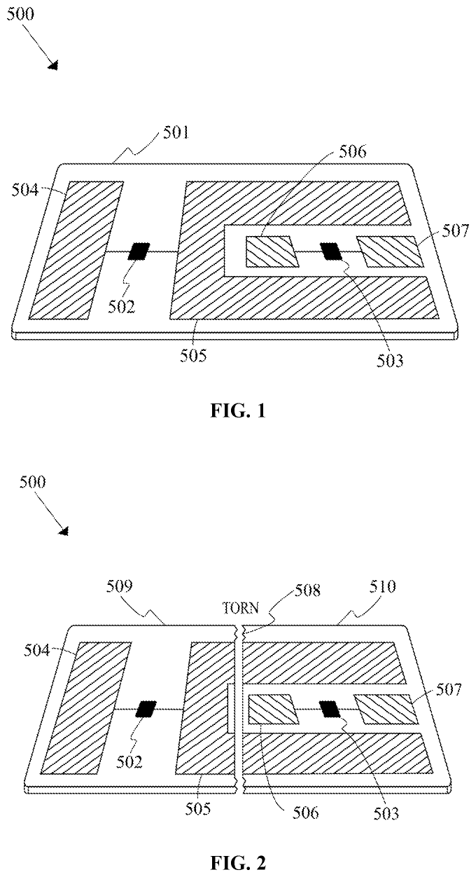

Referencing FIG. 1, in one embodiment, RFID tag 500 consists of antennas 504, 505, 506, 507 deposited on substrate 501. Antennas 504, 505 are preferably larger than antennas 506, 507. Antennas 504, 505 are connected to IC1 502 and antennas 506, 507 are connected to IC2 503. The value of the RFID tag 500 is generated from the RFID tag value stored in IC1 502 or IC2 503, depending on which of IC1 502 or IC2 503 is active at a given time. In one embodiment, only one of IC1 502 and IC2 503 is active at a given time. In this example, IC1 502 is active because the larger size of antenna 505 creates an interference in antennas 506, 507 such that the interference effectively inactivates IC2 503. In some embodiments, more than one substrate 501 can be used, and each of IC1 502 and IC2 503 can be connected to a single antenna or more than two antennas or can share an antenna. Antennas can be near-field or far-field or combination of near-field and far-field. Antennas can be made of different shapes, sizes and the like. More than two ICs can be used to represent a single RFID tag 500. In some embodiments, interference with IC2 503 can be achieved, for example, by the number of antenna segments connected to IC1 502. The greater number of antenna segments that are connected to IC1 502 relative to IC2 503, the stronger interference with IC2 503. In one embodiment, interference with IC2 503 can be achieved by, for example, fine tuning antennas 504, 505 relative to antennas 506, 507 to cause the less tuned antennas 506, 507 to be ineffective, and thereby, cause IC2 503 to be effectively inactive.

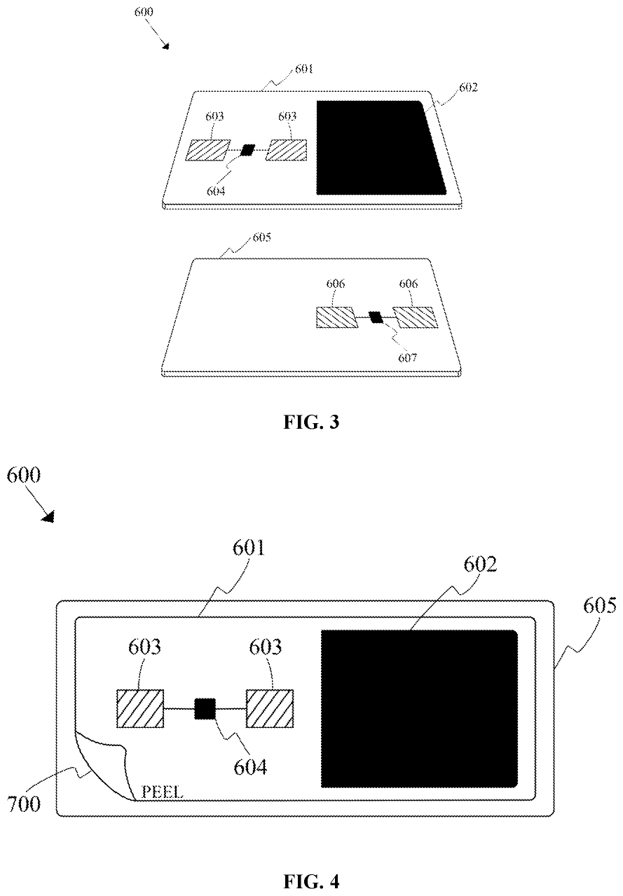

With reference to FIG. 2, RFID tag 500 can be configured to have a first portion 509 with IC 502 deposited on it, and a second portion 510 with IC 503 deposited on it. When RFID tag 500 is torn along line 508 to detach the first portion 509 from RFID tag 500, IC2 503 becomes active as antennas 506, 507 can absorb energy from an RFID reader without any interference from antennas 504, 505. The value associated with RFID tag 500 changes with the switch over from IC1 502 to IC2 503 without the need to reprogram the RFID tag value stored in IC1 502 or IC2 503.

The blocking of radio frequency electromagnetic waves can be advantageously used to control how and when the antenna of an RFID tag absorbs energy from the RFID reader to power the RFID tag. Referencing FIG. 3, RFID tag 600 has two layers. A top layer is substrate 601 and a bottom layer is substrate 605. In this embodiment, the bottom layer has an adhesive on the underside of substrate 605 (not shown in FIG. 3) which can be used to adhere the RFID tag 600 to the surface of the item that needs tracking. Antenna segments 603 are deposited on substrate 601 and are connected to IC 604. Antenna segments 606 are deposited on substrate 605 and are connected to IC 607. Antenna segments can be two segments of the same antenna or two separate antennas. Blocking material 602 is deposited on substrate 601 and is made of a material that prevents radio frequency electromagnetic waves to pass through it. When substrate 601 is layered over substrate 605, blocking material 602 prevents antenna segments 606 from absorbing radio frequency electromagnetic energy from an RFID reader to power IC 607. In this embodiment, IC 607 is dormant when substrate 601 is present, and therefore, only IC 604 is active. Therefore, the value of the RFID tag 600 is generated from the RFID tag value stored in IC 604. More than two layers, substrates and ICs can be used in RFID tag 600, and each IC can be connected to more than one antenna or can share an antenna and blocking material 602 can be made up of different materials known in the art to block radio frequency electromagnetic waves. Antennas can be near-field or far-field or combination of near-field and far-field. Substrates 601 and 605 can have different shapes and sizes. RFID tag 600 can also be constructed on a single layer or one substrate.

With reference to FIG. 4, when substrate 601 is peeled off with action 700, IC 604 is detached from RFID tag 600. Therefore, blocking material 602 no longer blocks antenna segments 606 (not shown in FIG. 4), thus making IC 607 (not shown in FIG. 4) active as the antenna segments 606 can then absorb energy from an RFID reader (not shown in FIG. 4). In this embodiment, the value associated with RFID tag 600 changes with the switch over from IC 604 to IC 607 without the need to reprogram the RFID tag value stored in IC 604 or IC 607.

Typically, a known RFID IC consists of two antenna terminals, a transmitter, a receiver, a Power Management Unit (PMU), a processor block and a memory to store data. The processor block can have additional components like memory, an encoder, a decoder, modulator, and demodulator as known in the art. The memory is typically implemented as a Nonvolatile Memory (NVM), wherein data is retained even when the circuit does not have power. The RFID circuit and/or the microprocessor may have additional components, or the processor and the circuit can be implemented in various ways known in the art.

Typically, the RFID IC memory has four memory subtypes, that is, reserved memory, Electronic Product Code (EPC) memory, Tag Identification (TID) memory, and user memory. All four memory subtypes are typically part of the same memory. The data within EPC memory and user memory in most cases can be reprogrammed with an RFID reader/writer. EPC can be a single number or a collection of several numbers together forming the EPC of an item.

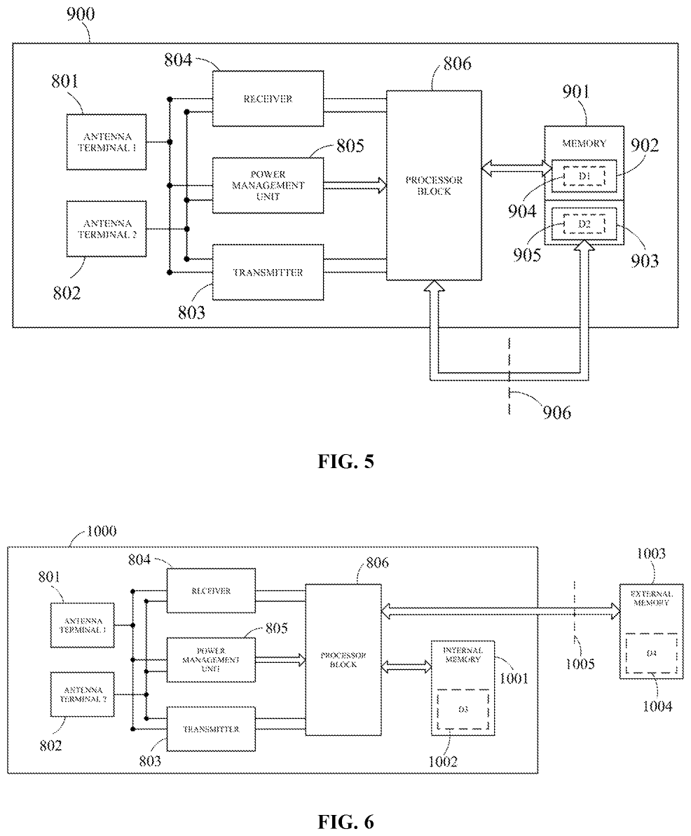

Referencing FIG. 5, RFID IC 900 can include memory 901 that is split into memory subsection 902 and memory subsection 903. In other embodiments, memory 901 maybe be split in more than two subsections, and the subsections need not have equal storage capacity. In one embodiment, each memory subsection 902, 903 has a separate connection to processor block 806. Data D1 904 is data stored in memory subsection 902 and data D2 905 is data stored in memory subsection 903. The connection between processor block 806 and memory subsection 902 is inside RFID IC 900, whereas the connection between processor block 806 and memory subsection 903 is traced externally outside of RFID IC 900. The external connection between processing block 806 and memory subsection 903 is externally accessible. When RFID IC 900 is interrogated by an RFID reader for the data stored in memory 901, processor block 806 processes the data stored in memory subsection 902 and memory subsection 903 and returns a single RFID tag value to the RFID reader, wherein the RFID tag value is a combination of data D1 904 and data D2 905. In one embodiment, the value of an RFID tag having RFID IC 900 is a combination of data stored in memory subsection 902, 903. When, the connection between processor block 806 and memory subsection 903 is disconnected, for example along the dotted line 906, processor block 806 can no longer access the data D2 905 stored in memory subsection 903. Therefore, processor block 806 can be programmed to either (a) only return data D1 904 stored in memory subsection 902 to the RFID reader, or (b) return data D1 904 and additionally default data in place of missing data D2 905 from disconnected memory subsection 903 to the RFID reader, thereby keeping the size of the data the same. In one embodiment, the value of the RFID tag can be changed/altered without reprogramming the data stored in the memory 901 of the RFID IC 900.

Referring FIG. 6, RFID IC 1000 has an internal memory 1001 connected to processor block 806. An external memory 1003 is connected to processor block 806. Data D3 1002 is stored in internal memory 1001 and data D4 1004 is stored in external memory 1003. In some embodiments, internal memory 1001 and/or external memory 1003 can each be split in subsections if desired and can have different storage capacities. The value of an RFID tag associated with RFID IC 1000 is derived, at least in part, from combining data D3 1002 stored in internal memory 1001 and data D4 1004 stored in external memory 1003. In one embodiment, the connection between processor block 806 and external memory 1003 is traced externally outside of RFID IC 1000 and is externally accessible. The connection to external memory 1003 can be disconnected by, for example, breaking the connection along the dotted line 1005 thus making external memory 1003 inaccessible by the processor block 806. Disconnecting external memory 1003 results in an RFID tag value defined by data stored in internal memory 1001 of RFID IC 1000 and without the data stored in external memory 1003. This is another method of altering/changing the value of the RFID tag without reprogramming the data stored in the internal memory 1001 or external memory 1003 with an external source such as an RFID reader/writer.

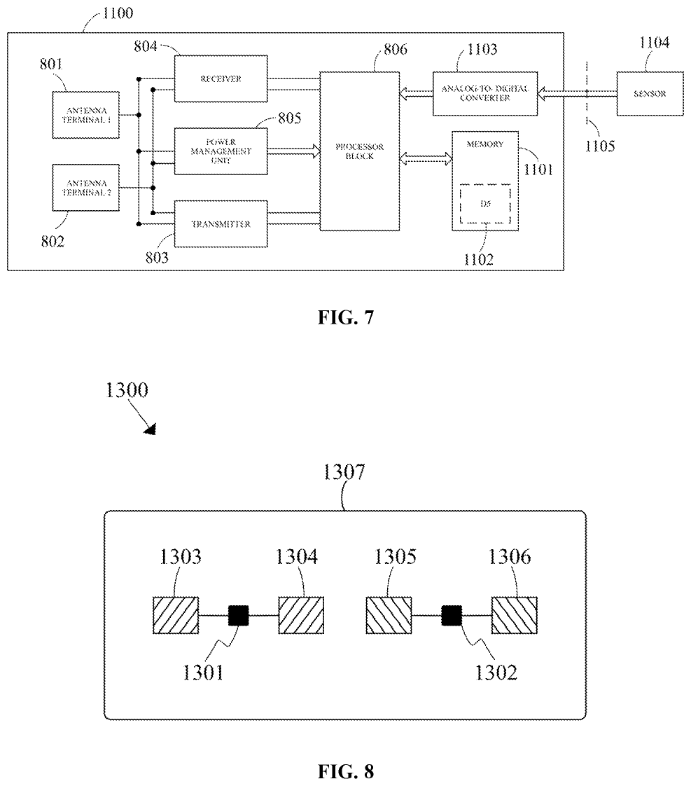

Referencing FIG. 7, RFID IC 1100 contains an Analog to Digital Converter (ADC) 1103 connected to processor block 806. Sensor 1104 is connected externally to ADC 1103 such that the connection between sensor 1104 and ADC 1103 is traced outside of RFID IC 1100 and is externally accessible. In one embodiment, sensor 1104 is located within RFID IC 1100, and the connection between sensor 1104 and ADC 1103 is traced outside of RFID IC 1100. ADC 1103 provides a digital input to processor block 806 which is converted from an analog signal provided by the sensor 1104 to ADC 1103. Sensor 1104 can be a temperature sensor, pressure sensor, resistances connected in series, and the like. In one embodiment, the value of an RFID tag is a combination of data stored in memory 1101 and the input provided by ADC 1103 to the processor block 806. When the external connection between sensor 1104 and ADC 1103 is broken, for example along the dotted line 1105, the input provided by ADC 1103 to processor block 806 changes thus, altering and changing the value of the RFID tag having RFID IC 1100 without the need to reprogram data D5 1102 stored in the memory 1101 of RFID IC 1100 with an external source such as an RFID reader/writer. In some embodiments, memory 1101 can each be split in subsections if desired and the subsections can have separate connections to the processor block 806.

Referencing FIG. 8, in one embodiment, RFID tag 1300 consists of antennas 1303, 1304, 1305 and 1306 deposited on substrate 1307. Antennas 1303 and 1304 are connected to primary IC 1301 and antennas 1305 and 1306 are connected to secondary IC 1302. In one embodiment, primary IC 1301 is assigned as primary and identified as primary using value stored in primary IC 1301. In some embodiments, secondary IC 1302 is assigned as secondary and identified as secondary using value stored in secondary IC 1302. Primary IC 1301 and secondary IC 1302 can have same or different storage capacities. Primary IC 1301 and secondary IC 1302 both are active simultaneously at a given time. The value of RFID tag 1300 is generated, at least in part, from the value stored in primary IC 1301 and the value stored in secondary IC 1302, or only from the value stored in primary IC 1301. Some of the data stored in the memory each IC 1301, 1302 is common, and it facilitates establishing a relationship to RFID tag 1300. In some embodiments, more than one substrate 1307 can be used, and each of IC 1301 and IC 1302 can be connected to a single antenna or more than two antennas or can share an antenna. Antennas can be near-field or far-field or combination of near-field and far-field. Antennas can be made of different shapes, sizes and the like. In some embodiments, more than two ICs can be used to represent a single RFID tag 1300.

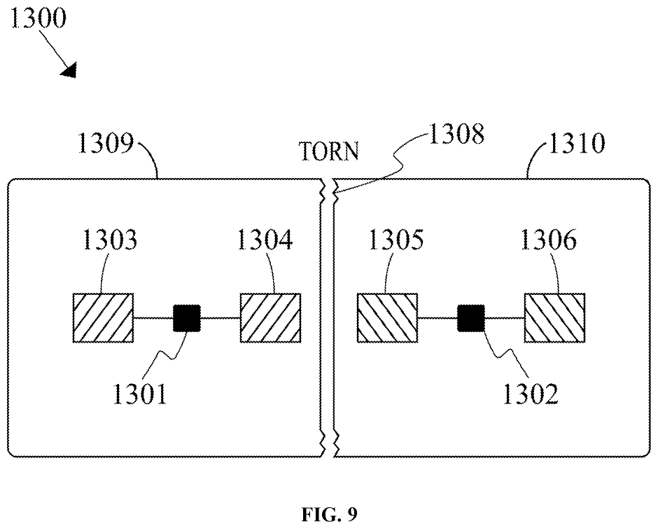

With reference to FIG. 9, RFID tag 1300 can be configured to have a first portion 1309 with primary IC 1301 deposited on it, and a second portion 1310 with secondary IC 1302 deposited on it. When RFID tag 1300 is torn along line 1308 to detach the second portion 1310 from RFID tag 1300, the value of RFID tag 1300 is generated from value stored only in primary IC 1301 and without the value stored in secondary IC 1302. The value associated with RFID tag 1300 changes with the absence of secondary IC from RFID tag 1300 without the need to reprogram the RFID tag value stored in the primary IC 1301 or secondary IC 1302 with an external source such as an RFID reader/writer.

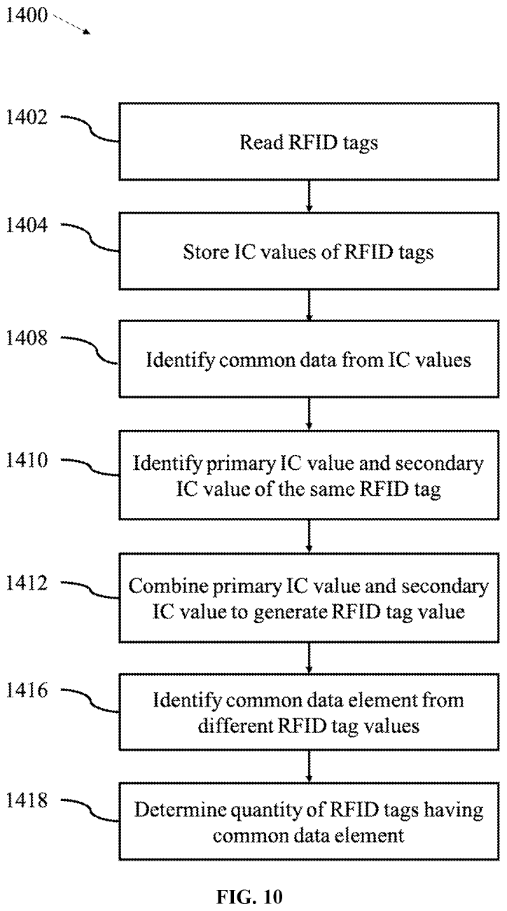

With reference to FIG. 1, FIG. 8 and FIG. 10, a method 1400 of managing RFID tags having one or more ICs is described. In one embodiment, an RFID reader reads RFID tags for their values and manages the RFID tags with multiple ICs where multiple ICs of the same RFID tag can be active simultaneously, like RFID tag 1300, or only one IC can be active at a given time, like RFID tag 500.

Referencing FIG. 10, in one embodiment, at a step 1402 the RFID tags are read by, for example, a RFID reader to determine the value stored in the IC of each RFID tag. In case of RFID tag 1300, the RFID reader reads each IC 1301, 1302 independently. Then at a step 1404, the value of each IC read is stored. In one embodiment, the value read and stored is the RFID tag value assigned to RFID tag 500 and stored in IC1 502 (where only IC1 502 is active at a given time and IC2 503 is dormant), and/or the values read and stored are the partial RFID tag values like in the case of primary IC 1301 and secondary IC 1302 of RFID tag 1300. At step 1408, common data of the stored IC values is identified. At step 1410, in one embodiment, the IC values that have common data are identified as primary IC value and secondary IC value based on, for example, the size of the memories and/or the content of the memories. At a step 1412, the primary IC value and the secondary IC value can be combined to generate a value for the RFID tag. IC values that do not have a common data matching with other IC values, like in the case of RFID tag 500, are designated as RFID tag value. By way of example, a warehouse space can store multiple items, where each item is tagged with at least one RFID tag. The items in the warehouse space can be of the same type or different types, say Type A and Type B. In one embodiment, items that are of the same type, say Type A, have a common data element in the value of the RFID tag to establish a relationship between items of Type A. At step 1416, the common data element between different RFID tag values is identified. At step 1418, RFID tag values that have a common data element can be counted and assigned a quantity for that item type; in such case, for example, a specific quantity of Type A items in the warehouse would be identified. In some embodiments, the stored values can be exported to external services at a subsequent step.

1. A Radio Frequency Identification (RFID) tag comprising:
a substrate;
a first integrated circuit (IC) deposited on the substrate;
a first antenna coupled to the first IC;
a second IC deposited on the substrate;
a second antenna coupled to the second IC;
wherein the first antenna is configured to cause an interference with the second antenna, and wherein such interference effectively inactivates the second IC;
wherein the substrate is configured to facilitate a detaching of a first portion of the substrate supporting the first IC from a second portion of the substrate supporting the second IC; and
wherein detaching of the first portion of the substrate effectively results in the activation of the second IC.

2. The RFID tag of claim 1, wherein a RFID tag value is derived from a value provided by the first IC or, alternatively, a value provided by the second IC, and further wherein detaching the first portion a RFID tag value is given by the value of the second IC, and wherein the RFID tag value, therefore, changes without a reprogramming of the value stored in the first IC or the value stored in the second IC.

3. A Radio Frequency Identification (RFID) tag comprising:
a first substrate;
a first integrated circuit (IC) deposited on the first substrate;
a first antenna coupled to the first IC;
a second substrate;
a second IC deposited on the second substrate;
a second antenna coupled to the second IC;
a blocking material deposited on the first substrate; and
wherein the blocking material is configured to cover the second IC and the second antenna to prevent the second antenna from receiving radio frequency electromagnetic waves.

4. The RFID tag of claim 3, wherein the first substrate is removable from the RFID tag to thereby remove the first IC, the first antenna and the blocking material, and wherein the RFID tag remains with the second IC and the second antenna, thereby, resulting in the second IC being capable of receiving radio frequency electromagnetic waves.

5. The RFID tag of claim 4, wherein a RFID tag value is derived from a value provided by the first IC or, alternatively, a value provided by the second IC, and further wherein removing the first substrate a RFID tag value is given by the value of the second IC, and wherein the RFID tag value, therefore, changes without a reprogramming of the value stored in the first IC or the value stored in the second IC.

6. An Integrated Circuit (IC) for a Radio Frequency Identification (RFID) tag, the IC comprising:
a processor block;
a memory comprising a first memory subsection and a second memory subsection;
wherein the first memory subsection and the second memory subsection are each separately, coupled to the processor block; and
wherein a coupling between the second memory subsection and the processor block is configured to be uncoupled and, thereby, prevent the processor block from receiving data from the second memory subsection.

7. The integrated circuit of claim 6, the coupling between the second memory subsection and the processor block is traced externally outside the integrated circuit.

8. The integrated circuit of claim 7, wherein the coupling is externally accessible.

9. The integrated circuit of claim 6, wherein a RFID tag value is derived from combining data stored in the first memory subsection and data stored in the second memory subsection, and further wherein uncoupling the second memory subsection results in a RFID tag value defined by data stored in the first memory subsection and without the data stored in the second memory subsection, and wherein the RFID tag value, therefore, changes without a reprogramming of the data stored in the first memory subsection or the data stored in the second memory sub section.

10. The integrated circuit of claim 6, the processor block is configured to return only data stored in the first memory subsection or, alternatively, data stored in the first memory subsection and default data, when the second memory subsection is uncoupled from the processor block.

11. An Integrated Circuit (IC) for a Radio Frequency Identification (RFID) tag, the IC comprising:
a processor block;
an internal memory coupled to the processor block;
an external memory coupled to the processor block; and
wherein a coupling between the external memory and the processor block is configured to be uncoupled and, thereby, prevent the processor block from receiving data from the external memory.

12. The integrated circuit of claim 11, the coupling between the external memory and the processor block is traced externally outside the integrated circuit and is externally accessible.

13. The integrated circuit of claim 11, wherein a RFID tag value is derived from combining data stored in the internal memory and data stored in the external memory, and further wherein uncoupling the external memory results in a RFID tag value defined by data stored in the internal memory and without the data stored in the external memory, and wherein the RFID tag value, therefore, changes without a reprogramming of the data stored in the internal memory or the data stored in the external memory.

14. An Integrated Circuit (IC) for a Radio Frequency Identification (RFID) tag, the IC comprising:
a processor block;
a memory coupled to the processor block;
an Analog-to-Digital Converter (ADC) coupled to the processor block;
a sensor coupled to the ADC; and
wherein a coupling between the ADC and the sensor is configured to be uncoupled and, thereby, prevent the ADC from receiving signals from the sensor.

15. The integrated circuit of claim 14, the coupling between the ADC and the sensor is traced externally outside the integrated circuit.

16. The integrated circuit of claim 15, wherein the coupling is externally accessible.

17. The integrated circuit of claim 14, wherein a RFID tag value is derived from combining data stored in the memory and an input to the processor block provided by the ADC, wherein uncoupling the sensor results in changing the input, and wherein the RFID tag value, therefore, changes without a reprogramming of the data stored in the memory.

18. A Radio Frequency Identification (RFID) tag comprising:
a substrate;
a first integrated circuit (IC) deposited on the substrate;
a first antenna coupled to the first IC;
a second IC deposited on the substrate;
a second antenna coupled to the second IC;
wherein the first IC and the second IC are configured to be active simultaneously at a given time;
wherein a value of the RFID tag is a combination of a value stored in the first IC and/or a value stored in the second IC; and
wherein some of the value stored in the first IC and some of the value stored in the second IC is common to facilitate a determination that the first IC and the second IC are associated with the RFID tag.

19. The RFID tag of claim 18, wherein the RFID tag comprises a first portion with the first IC deposited on the first portion, and wherein the RFID tag comprises a second portion with the second IC deposited on the second portion, and wherein the RFID tag is configured to facilitate a detaching of the second portion from the first portion.

20. The RFID tag of claim 19, wherein the RFID tag is configured to provide a RFID tag value given by the value of the first IC only, after the second portion is detached from the first portion, and wherein the RFID tag value of the RFID tag, therefore, changes without a reprogramming of the value stored in the first IC or the value stored in the second IC.
